(19) United States
(12) Patent Application Publication
(10) Pub. No.: US 2024/0383064 A1
(43) Pub. Date: Nov. 21, 2024

(54) METHOD OF FORMING AN IMPULSE WELD

(71) Applicant: Ohio State Innovation Foundation, Columbus, OH (US)

(72) Inventors: Anupam VIVEK, Columbus, OH (US); Glenn DAEHN, Columbus, OH (US)

(21) Appl. No.: 18/696,820

(22) PCT Filed: Sep. 30, 2022
(86) PCT No.: PCT/US22/45396

§ 371 Date: Mar. 28, 2024

Related U.S. Application Data
(60) Provisional application No. 63/251,348, filed on Oct. 1, 2021.

(51) Int. Cl. B23K 20/00; B23K 20/08; B23K 103/10; B32B 15/01

(52) U.S. Cl. CPC B23K 20/008; B23K 20/08; B32B 15/016; B23K 2103/10

(57) ABSTRACT

Disclosed are methods of forming an impulse weld in a stack comprising a plurality of metal layers. Also disclosed herein are welded products exhibiting lower electrical resistivity when compared to an electrical resistivity of a substantially identical reference stack that was not yet welded. Also disclosed herein are systems for making such welded products.

### CROSS-REFERENCE TO RELATED APPLICATIONS

This application claims the benefit of U.S. Provisional Application No. 63/251,348, filed Oct. 1, 2021, the content of which is incorporated herein by reference in its entirety.

### FIELD

The present invention relates generally to metal welded products and methods for making the same. The present invention also relates to welding systems used to produce the disclosed welded products.

### BACKGROUND

The technological developments in automotive and aircraft industries, batteries and electronic devices manufacture, and many other manufacturing fields, often depend on the successful implementation of multi-material construction that requires dependable and strong dissimilar joints of the materials.

When metals come into direct contact, they form a strong metallic bond by sharing their free electrons. This is the principle of cold welding. However, we don't see metals welding easily to each other by simply bringing them into contact because of impurities, such as oxides and lubricants, on the surfaces. Solid-state welding techniques such as friction stir, ultrasonic, and impact welding rely on stirring, vibration, and violent impact of the metals to break the oxide layer and cause welding to occur. There are, however, limitations to the applicability of each of these methods.

For example, impulse welding is typically practiced as impact welding, where two (or more) metallic pieces are placed at a certain distance from each other, and one (or both) of the pieces is launched toward the other. A very high-speed, angular impact results in a metallic bond during impact welding. However, this method is not suitable in certain cases. For example, when multiple very thin foils have to be welded, it is unfeasible to create a gap between each of them. Additionally, ductility limitations can cause foils' failure during launch or impact.

Other limitations also exist in joining thick plates. Often the processes used in industry are too slow and labor-intensive.

Thus, there is a need for methods to improve the welding of materials having various thicknesses and welding of materials that are present in the stack. Further, there is a need to provide a weld that can withstand harsh operation conditions without failure. These needs and other needs are at least partially satisfied by the present invention.

### SUMMARY

The present disclosure is generally directed to a method for producing an impulse weld in a stack comprising a plurality of metal layers, wherein the method comprises imparting rising pressure to at least a portion of a first metal layer in the stack wherein the pressure is effective to project the first metal layer towards the rest of the plurality of metal layers to form a metallurgical bond between the plurality of metal layers, and wherein a rate of a pressure rise is such that over about 50% of the pressure rise occurs in less than about 500 microseconds.

In still further aspects, the stack is substantially free of an intentional initial gap between one or more metal layers in the stack. In yet further aspects, the maximum value of the pressure is at least 2 times greater than a flow strength of at least one metal layer in the plurality of metal layers.

In still further aspects, the stack can have a thickness from about 0.5 microns to about 4 mm. In yet further aspects, the stack can comprise between 2 to about 1000 metal layers.

Also disclosed are methods where the pressure is generated by an energy source. In such exemplary aspects, the energy source generates the pressure through plasma, gas expansion by an electrical current, laser, electromagnetic source, detonation of an explosive and/or energetic material, electromagnetic repulsion, projectile of gun powder, spring projectile, or a combination thereof.

In still further aspects, the step of imparting the pressure comprises accelerating an auxiliary member towards the first metal layer of the plurality of metal layers. In some aspects, at least a portion of the auxiliary member comprises an ablative material configured to vaporize during the accelerating step. While in other aspects, at least a portion of the auxiliary member can comprise at least one chemical compound configured to react exothermically.

Also disclosed herein are aspects directed to a spot welded product produced by the disclosed herein methods.

In yet further aspects, disclosed is a welded product comprising a stack comprising a plurality of metal layers; wherein the plurality of metal layers is welded to each other by the disclosed herein methods; and wherein the welded product exhibits a lower electrical resistivity when compared to an electrical resistivity of a and wherein the welded product exhibits a lower electrical resistivity when compared to an electrical resistivity of a substantially identical reference stack that was not yet welded.

In further aspects, also disclosed herein is a system comprising: a stack comprising a plurality of metal layers; an auxiliary member configured to impart a pressure to a first metal layer of the plurality of metal layers and such to cause a spot welding of the plurality of metal layers; and an energy source configured to accelerate the auxiliary multi-layer member toward the first metal layer of the plurality of metal layers.

Additional aspects of the invention will be set forth, in part, in the detailed description, figures, and claims which follow, and in part will be derived from the detailed description or can be learned by practice of the invention. It is to be understood that both the foregoing general description and the following detailed description are exemplary and explanatory only and are not restrictive of the invention as disclosed.

### BRIEF DESCRIPTION OF FIGURES

FIG. 1 depicts a schematic of welding of the stack in one aspect.

FIG. 2 depicts optical photographs of the join obtained according to the schematics of FIG. 1.

FIG. 3 depicts optical photographs of the join obtained according to the schematics of FIG. 1 for aluminum and copper stacks.

FIG. 4 depicts a schematic of welding of the layer stack in a different aspect.

FIG. 5 depicts a schematic of welding variations in one aspect.

FIG. 6 depicts a schematic of welding variations in a different aspect.

FIG. 7 depicts an image of a welded alternating material stack comprising about 10 aluminum and 10 copper foils.

Additional aspects of the invention will be set forth, in part, in the detailed description, figures, and claims which follow, and in part will be derived from the detailed description or can be learned by practice of the invention. It is to be understood that both the foregoing general description and the following detailed description are exemplary and explanatory only and are not restrictive of the invention as disclosed.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

In this specification and in the claims that follow, reference will be made to a number of terms, which shall be defined to have the following meanings:

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a metal layer” includes two or more such metal parts, reference to “an energy source” includes two or more such energy sources, and the like.

Throughout the description and claims of this specification, the word “comprise” and other forms of the word, such as “comprising” and “comprises,” means including but not limited to, and are not intended to exclude, for example, other additives, components, integers, or steps. Furthermore, it is to be understood that the terms comprise, comprising, and comprises as they relate to various aspects, elements, and features of the disclosed invention also include the more limited aspects of “consisting essentially of” and “consisting of.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein, the term “and/or” includes any and all combinations of one or more of the associated listed items.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or a section. Thus, a first element, component, region, layer, or section discussed below could be termed a second element, component, region, layer, or section without departing from the teachings of example embodiments.

Spatially relative terms, such as “beneath,” “below,” “lower,” “above,” “upper.” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein are interpreted accordingly.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to indicate that the recited component is not intentionally batched and added to the composition but can be present as an impurity along with other components being added to the composition. In such aspects, the term “substantially free” is intended to refer to trace amounts that can be present in the batched components, for example, it can be present in an amount that is less than about 1% by weight, e.g., less than about 0.5% by weight, less than about 0.1% by weight, less than about 0.05% by weight, or less than about 0.01% by weight of the stated material, based on the total weight of the composition.

As used herein, the term “substantially,” in, for example, the context “substantially identical” or “substantially similar” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art using only routine experimentation. Although the operations of exemplary embodiments of the disclosed method may be described in a particular sequential order for convenient presentation, it should be understood that disclosed embodiments can encompass an order of operations other than the particular, sequential order disclosed. For example, operations described sequentially may, in some cases, be rearranged or performed concurrently. Further, descriptions and disclosures provided in association with one particular embodiment are not limited to that embodiment and may be applied to any embodiment disclosed.

As used herein, the terms “substantially identical reference composition” or “substantially identical reference article” refer to a reference composition or article comprising substantially identical components in the absence of an inventive component. In another exemplary aspect, the term “substantially,” in, for example, the context “substantially identical reference composition or article,” refers to a reference composition or article comprising substantially identical components and wherein an inventive component is substituted with a common in the art component. In another exemplary aspect, the term “substantially,” in, for example, the context “substantially identical reference method,” refers to a method comprising substantially identical steps in the absence of the inventive step or when the inventive step is substituted with a common in the art step.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

### Methods of Forming an Impulse Weld

As summarized above, disclosed herein is a method for producing an impulse weld in a stack comprising a plurality of metal layers, wherein the method comprises imparting rising pressure to at least a portion of a first metal layer in the stack wherein the pressure is effective to project the first metal layer towards the rest of the plurality of metal layers to form a metallurgical bond between the plurality of metal layers, and wherein a rate of a pressure rise is such that over about 50% of the pressure rise occurs in less than about 500 microseconds.

It is understood that in aspects disclosed herein, the pressure can be imparted such that the pressure rises rapidly with at least about 50%, at least about 60%, at least about 70%, at least about 80%, at least about 90%, or at least about 95% of all pressure rise occurs in less than about 500 microseconds, less than about 400 microseconds, less than about 300 microseconds, less than about 200 microseconds, less than about 100 microseconds, less than about 90 microseconds, less than about 80 microseconds, less than about 70 microseconds, less than about 60 microseconds, less than about 50 microseconds, less than about 40 microseconds, less than about 30 microseconds, less than about 20 microseconds, less than about 10 microseconds, less than about 1 microsecond, less than about 500 nanoseconds, less than about 400 nanoseconds, less than about 300 nanoseconds, less than about 200 nanoseconds, less than about 100 nanoseconds, less than about 90 nanoseconds, less than about 80 nanoseconds, less than about 70 nanoseconds, less than about 60 nanoseconds, less than about 50 nanoseconds, less than about 40 nanoseconds, less than about 30 nanoseconds, less than about 20 nanoseconds, less than about 10 nanoseconds, and less than about 1 nanoseconds.

In still further aspects, the stack is substantially free of an intentional initial gap between one or more metal layers in the stack. In yet other aspects, a natural gap caused by a geometry of the metal layer can be present. It is understood that this natural gap does not have to be uniform along the length of the metal layers or between different metal layers. In yet other aspects, an intentional initial gap can be introduced. It is understood that if the intentional initial gap is present such gap can be selected based on the desired application. It is further understood that if the intentional initial gap is present, such a gap can be created by any known in the art methods. For example, and without limitations, it can be created by inserting one or more spaces that can artificially create gaps in the desired locations.

In certain aspects, the maximum value of the pressure is at least 1 time, at least about 2 times, at least about 3 times, at least about 4 times, at least about 5 times, at least about 6 times, at least about 7 times, at least about 8 times, at least about 9 times, or at least about 10 times, greater than the flow strength of at least one of the metal layers in the plurality of metal layers. It is understood that the flow strength of the metal layer relates to the metal's ability to undergo plastic deformation, and it can be determined by one of the skilled in the art.

In still further aspects, the stack can have any thickness that is desired for the specific application. In some aspects, the metal layer can be a foil. While in other aspects, the metal layer can be a foil adhered to a different metal layer that is not a foil. In yet still further aspects, the metal layer is not a foil. In some aspects, the stack can have a thickness from about 0.5 microns to about 4 mm, including exemplary values of about 1 micron, about 5 microns, about 10 microns, about 15 microns, about 20 microns, about 30 microns, about 50 microns, about 75 microns, about 100 microns, about 125 microns, about 150 microns, about 175 microns, about 200 microns, about 225 microns, about 250 microns, about 275 microns, about 300 microns, about 325 microns, about 350 microns, about 375 microns, about 400 microns, about 425 microns, about 450 microns, about 475 microns, about 500 microns, about 525 microns, about 550 microns, about 575 microns, about 600 microns, about 625 microns, about 650 microns, about 675 microns, about 700 microns, about 725 microns, about 750 microns, about 775 microns, about 800 microns, about 825 microns, about 850 microns, about 875 microns, about 900 microns, about 925 microns, about 950 microns, about 975 microns, about 1 mm, about 1.2 mm, about 1.5 mm, about 1.8 mm, about 2 mm, about 2.2 mm, about 2.5 mm, about 2.8 mm, about 3 mm, about 3.2 mm, about 3.5 mm, and about 3.8 mm.

In still further aspects, a thickness of a metal layer in the plurality of metal layers can be from about 0.5 microns to about 4 mm, including exemplary values of about 0.7 microns, about 1.0 microns, about 2.0 microns, 3.0 microns, about 5.0 microns, about 7.5 microns, about 10.0 microns, about 15.0 microns, about 20.0 microns, about 25.0 microns, about 30.0 microns, about 35.0 microns, about 40.0 microns, about 45.0 microns, about 50.0 microns, about 55.0 microns, about 60.0 microns, about 65.0 microns, about 70.0 microns, about 75.0 microns, about 80.0 microns, about 85.0 microns, about 90.0 microns, about 95.0 microns, about 100.0 microns, about 120.0 microns, about 150.0 microns, about 180.0 microns, about 200.0 microns, about 220.0 microns, about 250.0 microns, about 280.0 microns, about 300.0 microns, about 320.0 microns, about 350.0 microns, about 380.0 microns, about 400.0 microns, about 420.0 microns, about 450.0 microns, about 480.0 microns, about 500 microns, about 525 microns, about 550 microns, about 575 microns, about 600 microns, about 625 microns, about 650 microns, about 675 microns, about 700 microns, about 725 microns, about 750 microns, about 775 microns, about 800 microns, about 825 microns, about 850 microns, about 875 microns, about 900 microns, about 925 microns, about 950 microns, about 975 microns, about 1 mm, about 1.2 mm, about 1.5 mm, about 1.8 mm, about 2 mm, about 2.2 mm, about 2.5 mm, about 2.8 mm, about 3 mm, about 3.2 mm, about 3.5 mm, and about 3.8 mm.

It is understood that in some aspects, each layer in the stack can have a thickness substantially different from other layers on the stack. While in other aspects, each layer in the stack can have a substantially similar thickness to at least one other layer in the stack. While in still other aspects, all layers in the stack can have substantially the same thickness. In yet further aspects, at least one of the first metal layer or the last metal layer of the stack can have a different thickness from the rest of the metal layers. In other aspects, the at least one of the first metal layer or the last metal layers has a thickness greater than a thickness of the rest of the metal layers. In still further aspects, the thickness of the first metal layer is the same as the thickness of the last layer. While in still further aspects, the thickness of the first metal layers is different than the thickness of the last layer.

In still further aspects, at least one of the metal layers can have a thickness that is substantially greater than the rest of the metal layers. In such exemplary aspects, the at least one of the metal layers can have a thickness greater than about 4 mm, greater than about 1 cm, greater than about 1 inch, or even greater than about 10 inches.

In still further aspects, the stack can comprise any number of layers that can result in the desired thickness of the stack or the desired application. In some aspects, the stack can comprise between about 2 to about 1000 metal layers, including exemplary values of about 3 layers, about 5 layers, about 10 layers, about 20 layers, about 30 layers, about 40 layers, about 50 layers, about 60 layers, about 70 layers, about 80 layers, about 90 layers, about 100 layers, about 150 layers, about 200 layers, about 250 layers, about 300 layers, about 350 layers, about 400 layers, about 450 layers, about 500 layers, about 550 layers, about 600 layers, about 650 layers, about 700 layers, about 750 layers, about 800 layers, about 850 layers, about 900 layers, and about 950 layers.

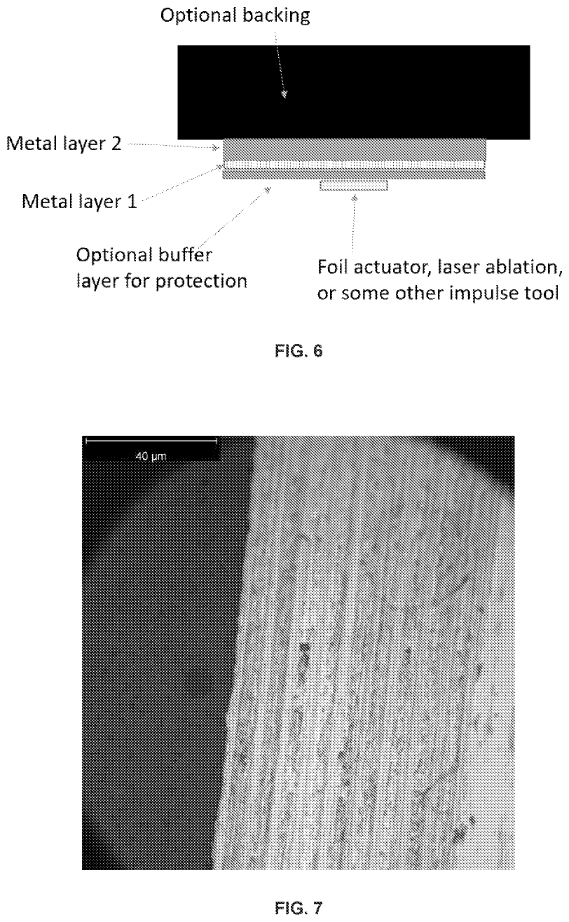

In certain aspects, and as shown in FIG. 6, for example, the stack can comprise at least one metal layer that is substantially greater than another metal layer.

In still further aspects, the metal layers that can be welded by the methods disclosed herein can comprise aluminum, copper, zinc, titanium, iron, nickel, lithium alloys thereof, or alloys or a combination thereof. It is understood that the stack can comprise layers comprising the same metal or different ones. In some aspects, at least two layers are substantially the same. While in other aspects, the layers can be different by the composition or the process they were subjected to prior to the welding procedures.

Also disclosed are aspects where each of the plurality of metal layers are substantially similar to each other. In such exemplary aspects, the similarity can be in a layer composition, geometry, and/or thickness. For example, in some aspects, each of the plurality of metal layers comprises a substantially similar composition. Yet in other exemplary aspects, the each of the plurality of metal layers can have a substantially similar geometry. Yet in still further aspects, the each of the plurality of metal layers can have a substantially similar thickness. Yet in still further aspects, the each of the plurality of metal layers comprises a substantially similar composition and a substantially similar geometry. While in other aspects, the each of the plurality of metal layers comprises a substantially similar composition and a substantially similar thickness. In still further aspects, the each of the plurality of metal layers comprises a substantially similar composition, a substantially identical geometry, and a substantially similar thickness.

Also disclosed are aspects where at least two metal layers in the plurality of metal layers are different. In such exemplary aspects, the layers can be different in a composition, geometry, and/or thickness. For example, in some aspects, the at least two metal layers in the plurality of metal layers have a substantially different composition. Yet in other exemplary aspects, the at least two metal layers in the plurality of metal layers have a substantially different geometry. Still, in further aspects, the at least two metal layers in the plurality of metal layers have a substantially different thicknesses. Yet, in still further aspects, the at least two metal layers in the plurality of metal layers have a substantially different composition and a substantially different geometry. While in still further aspects, the at least two metal layers in the plurality of metal layers have a substantially different composition and a substantially different thickness. Yet, in still further aspects, the at least two metal layers in the plurality of metal layers have a substantially different composition, a different geometry, and a substantially different thickness. In still further aspects, the at least two metal layers in the plurality of metal layers are adjacent to each other in the stack. In yet still, further aspects, three or more of metal layers in the plurality of metal layers are different and positioned in alternating order in the stack.

In yet still further aspects, when the metal layers comprise alloys, at least some of the alloys can have yield strength of less than about 800 MPa, less than about 750 MPa, less than about 700 MPa, less than about 650 MPa, less than about 600 MPa, less than about 550 MPa, less than about 500 MPa, less than about 450 MPa, less than about 400 MPa, less than about 350 MPa, less than about 300 MPa, less than about 250 MPa, less than about 200 MPa, less than about 150 MPa.

For example, in some aspects, at least one of the metal layers of the plurality of metal layers can have an oxide layer formed at one or both surfaces of the metal layer. In yet other aspects, at least one of the metal layers of the plurality of metal layers can have a coating on either or both surfaces of the metal layer. In such aspects, the coating can comprise e-coating, a galvanized coating, galvannealed coating, paint, adhesive, sealant, or any combination thereof.

It is further understood that the methods disclosed herein can be used for welding of the metal layers in the stack having different surface finishes. For example, and without limitations, in some aspects, at least a portion of the second portion of the second surface of the second metal part is substantially flat. In yet other aspects, any portion of the second surface of the second metal part can be substantially flat. In still further aspects, at least one surface of at least one metal layer can be textured or can have roughness, or it can even be patterned.

It is understood that the roughness, if present, as disclosed herein, can be a natural characteristic of the metal layer that was not polished or processed, for example. Yet, in other aspects, the roughness can be intentionally introduced. Yet, in still further aspects, the roughness can be a part of the metal part design. In still further aspects, the roughness can have any desired shape. For example, and without limitations, the roughness can have a saw-like shape.

In still further aspects, the pressure can be generated by an energy source. In certain aspects, the energy source generates the pressure through plasma, gas expansion by an electrical current, laser, electromagnetic source, detonation of an explosive and/or energetic material, electromagnetic repulsion, projectile of gun powder, spring projectile, or a combination thereof. In some exemplary and unlimiting aspects, the energy source can be a capacitor or a plurality of capacitors arranged to be in communication with one or more auxiliary multi-layer members. In yet another exemplary aspect, the energy source is a laser.

In still further aspects, the step of imparting the pressure comprises accelerating an auxiliary member towards the first metal layer of the plurality of metal layers. In yet still further aspects, the pressure is produced by the impact of an auxiliary member and the first metal layer. In still further aspects, the energy source initiates acceleration of the auxiliary member towards the first metal layer, thereby imparting the pressure to the first metal layer of the stack.

In still further aspects, the accelerating step can comprise imparting an amount of energy to the auxiliary member. In some aspects, the amount of energy is selected to be effective to accelerate the auxiliary member such that the desired amount of pressure is provided to the first layer of the plurality of the layers. It is further understood that in certain aspects disclosed herein, the auxiliary member is consumable. Yet, in other aspects, the auxiliary member can comprise one or more layers.

In still further aspects, the energy source can provide energy from about 1 J to about 300 KJ, including exemplary values of about 10 J, about 20 J, about 30 J, about 40 J, about 50 J, about 60 J, about 70 J, about 80 J, about 90 J, about 100 J, about 150 J, about 200 J, about 250 J, about 500 J, about 750 J, about 1 kJ, about 10 KJ, about 20 kJ, about 50 KJ, about 80 KJ, about 100 kJ, about 125 kJ, about 150 kJ, about 180 KJ, about 200 kJ, about 225 kJ, about 250 kJ, and about 280 kJ. It is understood that the energy source can provide energy having a value between any two foregoing values.

In still further aspects, the energy source can provide energy from about 0.001 kJ to about 10 KJ, including the exemplary value of about 0.005 kJ, about 0.01 kJ, about 0.03 kJ, about 0.05 kJ, about 0.08 KJ, about 0.1 kJ, about 0.15 kJ, about 0.20 KJ, about 0.25 kJ, about 0.35 kJ, about 0.40 KJ, about 0.45 KJ, about 0.50 KJ, about 0.55 KJ, about 0.60 KJ, about 0.65 kJ, about 0.7 kJ, about 0.75 KJ, about 0.80 KJ, about 0.85 KJ, about 0.90 KJ, and about 0.95 KJ, about 1 KJ, about 1.5 kJ, about 2 KJ, about 2.5 kJ, about 3 kJ, about 3.5 kJ, about 4 KJ, about 4.5 kJ, about 5 kJ, about 5.5 kJ, about 6 kJ, about 6.5 kJ, about 7 KJ, about 7.5 kJ, about 8 kJ, about 8.5 kJ, about 9 KJ, and about 9.5 kJ. It is understood that the energy source can provide energy having a value between any two foregoing values.

In some exemplary aspects where the energy source is a laser, such a laser is capable of emitting light in a predetermined range of wavelength. In some aspects, the laser emits from about 1 to about 1000 joules per microsecond, including exemplary values of about 5 joules per microsecond, about 1 joule per microsecond, about 20 joules per microsecond, about 30 joules per microsecond, about 40 joules per microsecond, about 50 joules per microsecond, about 60 joules per microsecond, about 70 joules per microsecond, about 80 joules per microsecond, about 90 joules per microsecond, about 100 joules per microsecond, about 150 joules per microsecond, about 200 joules per microsecond, about 300 joules per microsecond, about 400 joules per microsecond, about 500 joules per microsecond, about 600 joules per microsecond, about 700 joules per microsecond, about 800 joules per microsecond, about 900 joules per microsecond.

In yet other aspects, the can laser emit light from about 1 to about 100 joules over a period of 1 to 200 nanoseconds, including exemplary values of about 1, 3, 10, 20, 30, 40, 50, 60, 70, 80, and 90 joules over a period of about 3, 5, 10, 20, 30, 40, 50, 60, 70, 80, 90, 100, 110, 120, 130, 140, 150, 160, 170, 180, and 190 nanoseconds.

In still further aspects, the laser emits light in pulses. For example, in some aspects, the laser provides at least one pulse. Yet, in other aspects, the laser provides at least 2 pulses, at least 5 pulses, at least 10 pulses, at least 20 pulses, at least 100 pulses. In yet other aspects, the laser can emit light in a series of pulses, for example, up to 10 pulses per second in a sequence. In yet still further aspects, the laser beam can be moved across the length of the stack to ensure sufficient welding.

In some aspects, the at least one pulse has a predetermined laser pulse duration. In some aspects, the predetermined laser pulse duration can be anywhere between about 1 ns to about 500 ns, including exemplary values of about 2 ns, about 3 ns, about 4 ns, about 5 ns, about 6 ns, about 7 ns, about 8 ns, about 9 ns, about 10 ns, about 20 ns, about 30 ns, about 40 ns, about 50 ns, about 60 ns, about 70 ns, about 80 ns, about 90 ns, about 100 ns, about 120 ns, about 150 ns, about 180 ns, about 200 ns, about 220 ns, about 250 ns, about 270 ns, about 300 ns, about 320 ns, about 350 ns, about 370 ns, about 400 ns, about 420 ns, about 450 ns, and about 470 ns.

In still further aspects, the auxiliary member is accelerated at speed from about 200 m/s to about 1000 m/s, including exemplary values of about 250 m/s, about 300 m/s, about 350 m/s, about 400 m/s, about 450 m/s, about 500 m/s, about 550 m/s, about 600 m/s, about 650 m/s, about 700 m/s, about 750 m/s, about 800 m/s, about 850 m/s, about 900 m/s, and about 950 m/s.

In some additional aspects, at least a portion of the auxiliary member comprises an ablative material configured to vaporize during the accelerating step. While in other aspects, at least a portion of the auxiliary member comprises at least one chemical compound configured to react exothermically. In such exemplary aspects, the at least one compound can be an explosive material configured to at least partially vaporize during the accelerating step.

In still further aspects, any of the disclosed herein energy sources can transfer the energy to the chemical compound, if present, to cause an exothermic reaction that would generate the desired pressure impacted towards the first metal layer of the plurality of metal layers. For example, and without limitations, an optical energy source can be used to initiate an explosive reaction. While in other exemplary aspects, a plasma can be used to initiate an explosive reaction and impact the pressure to the first metal layer of the plurality of metal layers.

In still further aspects, the ablative material if present in the auxiliary member is configured to evaporate and to impart kinetic energy as measured from 0.5 J/cm² to 5 KJ/cm², including exemplary values of about 0.7 J/cm², about 1 J/cm², about 1.2 J/cm², about 1.5 J/cm², about 1.7 J/cm², about 2 J/cm², about 2.2 J/cm², about 2.5 J/cm², about 2.7 J/cm², about 3.0 J/cm², about 3.2 J/cm², about 3.5 J/cm², about 3. J/cm², about 4.0 J/cm², about 4.2 J/cm², about 4.5 J/cm², and about 4.7 J/cm² to the first metal layer of the plurality of metal layers.

In certain aspects, the first layer of the auxiliary multi-layer member can comprise any conductive material that can be vaporized under effective conditions. In still further aspects, the auxiliary member can comprise aluminum, steel, copper, magnesium, zinc, nickel, lithium, or alloys or any combination thereof. In still some other aspects, the auxiliary member used herein can be referred to as vaporizing foil actuator welding or VFAW.

The auxiliary members disclosed herein can comprise additional layers and compositions.

In some aspects, the auxiliary member can further comprise a transparent material. In such exemplary aspects, the transparent material is configured to receive energy from the energy source and to transfer such energy to an abatable material, for example, the chemical compound disclosed herein. In yet further aspects, this transparent material can be configured to confine an expanding gas or plasma that is formed as a result of the exothermic reaction. In such exemplary aspects, the transparent material can comprise water, glass, or a transparent polymer.

In still further aspects, the auxiliary member can also comprise a high shock impedance material. In such aspects, the first layer of the auxiliary multi-layer member comprises glycerin, water, or a combination thereof.

In some aspects, an auxiliary member comprising such transparent material and a chemical compound can be supplied as a separate pack, or it can be formed in situ. For example, and without limitations, the auxiliary multi-layer member can be formed in-situ by providing a first stream of glycerin, water, or a combination thereof and a second layer or stream of sodium azide, nitromethane comprising material, one or more oxidants, or oxidizing materials, or any combination thereof.

In aspects where the auxiliary member comprising a chemical compound configured to react exothermically, such a member can impart energy from 0.5 J/cm² to about 5,000 J/cm², including exemplary values of about 1 J/cm², about 5 J/cm², about 10 J/cm², about 30 J/cm², about 50 J/cm², about 70 J/cm², about 100 J/cm², about 250 J/cm², about 500 J/cm², about 750 J/cm², about 1,000 J/cm², about 1,250 J/cm², about 1,500 J/cm², about 1,750 J/cm², about 2,000 J/cm², about 2,250 J/cm², about 2,500 J/cm², about 2,750 J/cm², about 3,000 J/cm², about 3,250 J/cm², about 3,500 J/cm², about 3,750 J/cm², about 4,000 J/cm², about 4,250 J/cm², about 4,500 J/cm², and about 4,750 J/cm², to the first metal layer of the plurality of metal layers.

In still further aspects, the auxiliary member comprises one or more layers comprising a metal, a polymer, an adhesive material, a cushioning material, an elastomeric material, a sealing material, or any combination.

In still further aspects, the exemplary auxiliary members can be any members as described in the U.S. Provisional Application Nos. 62/951,881 and 62/951,882, International Patent Application No. PCT/US2020/066155, U.S. patent application Ser. No. 17/787,001, the contents of which are incorporated herein by reference in their full entirety.

In still further aspects, any of the disclosed herein auxiliary members can be positioned on a supplementary member. In such aspects, the supplementary member is configured to project towards the first metal layer of the plurality of metal layers. In some aspects, the supplementary member can also be referred to as a flyer. In some aspects, the auxiliary member receives the energy from the energy source and accelerates that supplementary member towards the first metal layer. In certain aspects, an auxiliary member and/or the supplementary member can be positioned at a predetermined distance from the first metal layer of the plurality of metal layers. In such aspects, the predetermined distance can be from about 1 micrometer to about 5 mm, including exemplary values of about 5 micrometers, about 10 micrometers, about 20 micrometers, about 50 micrometers, about 100 micrometers, about 500 micrometers, about 1 mm, about 1.5 mm, about 2 mm, about 2.5 mm, about 3 mm, about 3.5 mm, about 4 mm, and about 4.5 mm.

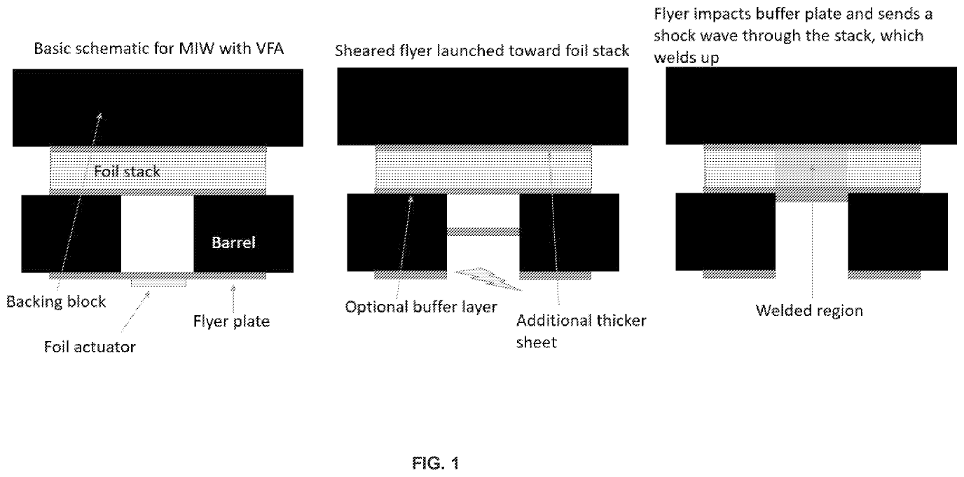

In still further aspects, the predetermined distance can be defined by one or more spacers positioned between the stack, the auxiliary, and/or supplementary member. In such exemplary aspects, the spacer can also have an edge with the purpose of shearing the auxiliary member to separate it from a larger supplementary member, such as a flyer, as shown in FIG. 1. This is shown explicitly in FIG. 1. In such exemplary aspects, a hole can be punched out of a larger flyer sheet, and the circular region flies and makes contact. Without being bound by any theory, it was suggested that such an approach can provide additional advantages: the pressure can be built before shearing to improve efficiency, and it would allow a substantially flat launch with a small gap.

In some exemplary and unlimiting aspects, the auxiliary multi-layer member can also comprise one or more alignment features. It is understood that these alignment features can be used to properly position the auxiliary member or supplementary member relative to the metal stack. Any known in the art alignment features can be utilized, for example, the alignment features can comprise markings, shapes such as various protrusions or indentations, apertures, or any combination thereof.

In still further aspects, the supplementary member can comprise a metal or a non-metal. In yet further aspects, the supplementary member has a thickness of about 10 microns to about 5 mm, including exemplary values of about 20 micrometers, about 50 micrometers, about 100 micrometers, about 150 micrometers, about 200 micrometers, about 500 micrometers, about 1 mm, about 1.5 mm, about 2 mm, about 2.5 mm, about 3 mm, about 3.5 mm, about 4 mm, and about 4.5 mm.

In still further aspects, the supplementary member is the metal material and wherein the metal material comprises a metal that is the same or different from any metal layers present in the plurality of metal layers.

In certain aspects, the supplementary member or a flyer can be presented, for example, as a sheet. In still further aspects, the supplementary member is the metal material comprising aluminum, steel, copper, zinc, brass, any alloys thereof, or any combination thereof. In certain aspects, the flyer or the supplementary member can be aluminum. Yet in other exemplary aspects, the flyer can be brass. Yet, in still further aspects, the flyer can be steel. In still further aspects, the supplementary member can have any desired thickness for a specific application. For example, and without limitations, the supplementary member can have a thickness from about 10 microns to about 10 mm, including exemplary values of about 25 microns, about 50 microns, about 75 microns, about 100 microns, about 200 microns, about 300 microns, about 400 microns, about 500 microns, about 600 microns, about 700 microns, about 800 microns, about 900 microns, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, and about 9.5 mm.

Without wishing to be bound by any theory, it was unexpectedly found that the supplementary member made out of a denser material such as brass can yield a substantially stronger weld upon impact with the multi-layer stack up as compared to the supplementary member made from a rarer material such as aluminum.

For example, it was unexpectedly found that a 0.5 mm thick brass sheet yielded consistent and better welding while welding an all-aluminum stack up as well as an aluminum-copper alternating layered stack up. Again, without wishing to be bound by any theory, it was hypothesized that with all other impact conditions being equal, a denser impactor can generate a higher amplitude shock wave that can cause greater shear stresses at the interfaces and result in breakage of and subsequent bonding of the surfaces in contact.

In yet further aspects, the last layer of the plurality of layers is positioned on a support material. In such aspects, it is understood that the support material can have a thickness larger than the thickness of the stack. In some aspects, the support material ensures that the stack remains in the desired position during the welding process and reduces the damage to the outermost surface of the stack. The support material also confines the stack from motion and confines motion to develop pressure. It acts as an anvil in a hammer forging operation

In still further aspects, a surface of the support material that is in contact with the last layer of the plurality of layers is flat, patterned, or a combination thereof.

In still further aspects, one or more buffer layers can be positioned between the auxiliary member and/or supplementary member and the first metal layer of the stack. Yet, in other aspects, one or more buffer layers can also be positioned between the last metal layer of the stack and the support material.

In still further aspects, the methods disclosed herein can be directed to the cladding of corrosion-resistant/scratch-resistant/sacrificial/in-other-way-functional layer(s) onto another layer by single or multiple side-by-side operations of this type. In such aspects, at least one of the plurality of metal layers is corrosion resistant. In yet other aspects, at least one of the plurality of metal layers is scratch resistant. In yet still further aspects, at least one of the plurality of metal layers is a sacrificial layer. In yet still further aspects, more or two potions of the plurality of metal layers are welded.

In still further aspects, the methods disclosed herein can comprise imparting the rising pressure sequentially. In such exemplary aspects, a continuous seam weld can be formed. In still further aspects, the rising pressure can be sequential and overlapping.

In still further aspects, the disclosed herein methods can form a welded product where a metal layer is coated or clad to a base member by using an array of rastered impulses as disclosed. In such aspects, the base member can have a thickness that is greater than the thickness of the metal layer.

### Welded Product

As summarized above, disclosed herein is a spot welded product produced by the methods disclosed herein. In certain aspects, such a product can comprise multiple layers of a thin material joined to themselves or a base structure.

In still further aspects, disclosed is a welded product comprising a stack comprising a plurality of metal layers; wherein the plurality of metal layers are welded to each other by the methods disclosed herein and wherein the welded product exhibits a lower electrical resistivity when compared to an electrical resistivity of a substantially identical reference stack that was not yet welded.

Also disclosed is a welded product formed by the described above methods, wherein at least one of the metal layers is coated.

In still further aspects, at least one of the metal layers is cladded to a base member by the disclosed methods, and wherein the base member has a greater thickness than the at least one metal layer.

Also disclosed are aspects where a continuous seam weld formed between a plurality of metal layers formed by the methods described herein and where the pressure rise is sequential and overlapping.

It is understood that the welded products disclosed herein can be utilized in any desired industry, for example, and without limitations, it can be utilized in the auto industry, aircraft, medical, defense, electronics, batteries, or spacecraft industries.

### System

Still further disclosed herein is a system comprising: a first member comprising: a stack comprising a plurality of metal layers; an auxiliary member configured to impart pressure to a first metal layer of the plurality of metal layers and such to cause a spot welding of the plurality of metal layers; and an energy source configured to accelerate the auxiliary multi-layer member toward the first metal layer of the plurality of metal layers.

The system disclosed herein further comprises an energy source configured to be in electrical communication with at least the auxiliary multi-layer member.

### EXAMPLES

### Example 1

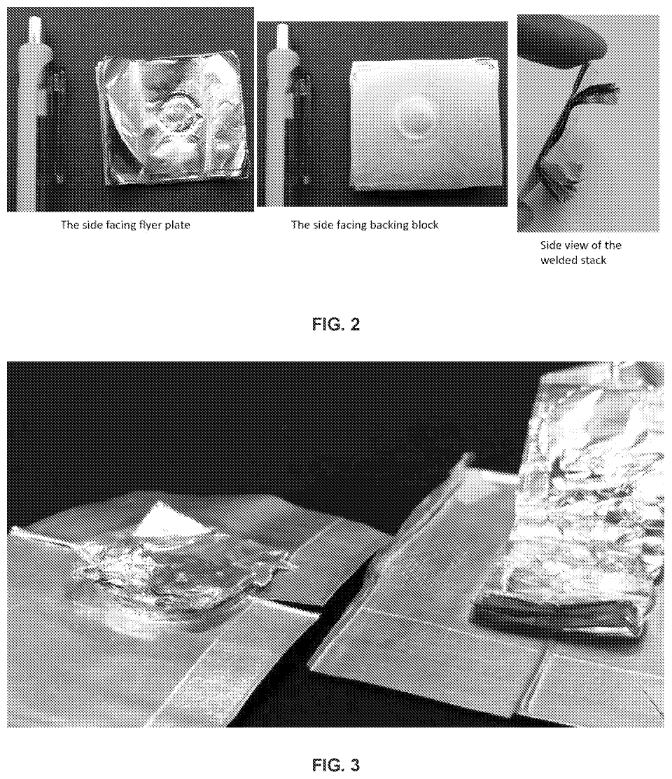

A stack of thin foils was welded according to the methods disclosed herein. Some exemplary and unlimiting schematic of the methods used to form such welded product is shown in FIG. 1, and photographs of the welded stack are shown in FIG. 2.

A stack of 35 aluminum foils, each 18 microns thick, was placed on an anvil (or, as referred herein, a support material). The anvil can have a flat surface or patterned surface, as shown in FIG. 5. The stack was impacted by another aluminum sheet (a flyer) launched by a vaporizing foil actuator. The actuator can be of some other type as well (electromagnetic, laser ablation, gas gun, explosive, compressed air, etc.). It was observed that not just the flyer sheet welded to the first foil it impacted but also the subsequent foils in the stack were welded to each other. The last foil in the stack was also found welded to the anvil. As there was no gap between the foil layers, they did not get launched at each other, but rather the shock wave emanating from the high-speed flyer impact with the first foil led to a shear deformation at all the interfaces and caused breakage of the resilient oxide layer. This resulted in welding without gross motion between the foils. Similar behavior was observed with stacked copper foils (FIG. 3). Breakage of the surface layer can also be accomplished by impulse forming the stack into a small cavity and causing the requisite shear deformation. This method can also be utilized to weld dissimilar metal combinations, and there is no upper or lower limit to the number of foils in the stack. Furthermore, the presence of a flyer sheet is also not necessary as long as the requisite shear deformation can be attained.

In certain aspects, the methods disclosed herein can be utilized for welding of lithium battery packs which have dozen to hundreds of copper and aluminum foils welded together and terminated into copper-nickel and aluminum leads. Ultrasonic welding is the current state-of-the-art technology and has tool longevity and repeatability issues. Impulsed stacked welding, as described herein, will overcome those challenges and provide a way of welding of foils and leads all at the same time. It will also be possible to weld through thin coatings. This will speed up the coating application process for battery pack production, which, currently, has to keep away from the foil terminations to allow for ultrasonic welding.

### Example 2

Commonly, when thick plate sections are welded to create a lap joint between two plates, a cavity is machined in one of the plates and a protruding “island” is a machine in the other. The edge of the island has a slight taper. As the island is pushed into the cavity by a high-speed actuator such as the vaporizing foil actuator, the two features rub against each other. The relative motion causes the breakage of surface contaminants such as oxides along with some heat generation. Once the motion stops, if the contacting surfaces are still clean, a strong metallic bond is created. An application for this type of joint is for hermetically sealing a closed box section, such as cooling channels in hollow turbine blades. Currently, this is done by diffusion bonding, which is a slow process. Impulsed welding can accomplish the high-quality joint within less than 0.01% of the time required by diffusion bonding. Other methods to do this could be friction stir welding or explosive welding. However, friction stir welding generates a significant amount of heat and can change the parent material properties, and explosive welding is difficult to control and automate in a typical factory environment. Impulsed welding provides a unique approach to overcoming these challenges presented by state-of-the-art technologies.

### Example 3

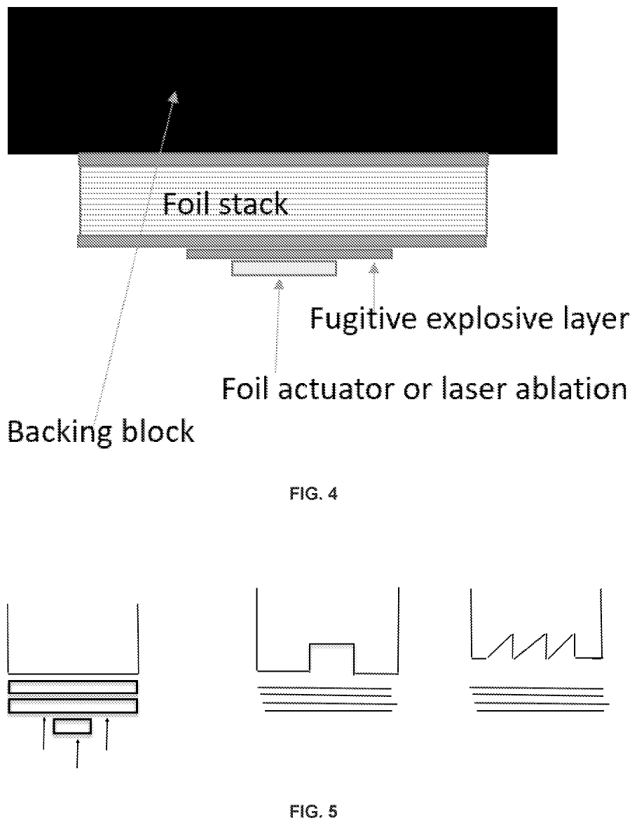

The stack of materials to be welded was impinged upon by a flyer plate traveling at high speed (similar to Example 1). The layer facing the flyer plate, the buffer plate, is mainly there to receive the impact and any damage from it and transmit the mechanical impulse into the rest of the stack, causing the latter to weld. The mechanism of welding is yet to be fully understood. Also, process limits of how many and how thick layers and which materials can be welded have not been fully explored. The example shown in the attachment is a stack of 36, 1xxx series aluminum foils, each 0.05 mm thick and 2, 1xxx series aluminum sheets, each 0.3 mm thick, all welded together in a single shot by the MIW method. The buffer layer used here was the 1xxx series, 0.3 mm thick aluminum sheet and the flyer plate was a 1 mm thick, 3003 aluminum alloy sheet, sheared by a vaporizing foil actuator and launched through a 10 mm diameter circular barrel, 3.175 mm long. We found the electrical resistance of the stack up to decrease by three orders of magnitude after welding. All the dimensions of the tooling and materials used in this example can be modified as needed. We also envision that non-circular spots can be welded by launching non-circular flyer plates toward the stack up. The mechanical impulse can be generated by other methods than a flyer plate impact, such as laser ablation, explosive, or a vaporizing foil actuator, and the impacting flyer plate can be launched by other methods besides VFA, as shown for example in FIG. 4.

### Example 4

FIG. 7 shows a cross-section image of a welded alternating material stack up consisting of 10 aluminum and 10 copper foils. A 4 kj input energy from a capacitor back into a vaporizing foil actuator was used to shear and launch a 0.5 mm thick brass sheet toward the stack of foils constrained on either side by aluminum buffer layers. The following image shows a micrograph of the welded stack up demonstrating the welded interfaces.

### Exemplary Aspects

In view of the described processes and compositions, hereinbelow are described certain more particularly described aspects of the disclosures. These particularly recited aspects should not, however, be interpreted to have any limiting effect on any different claims containing different or more general teachings described herein, or that the “particular” aspects are somehow limited in some way other than the inherent meanings of the language and formulas literally used therein.

EXAMPLE 1: A method for producing an impulse weld in a stack comprising a plurality of metal layers, wherein the method comprises: imparting rising pressure to at least a portion of a first metal layer in the stack wherein the pressure is effective to project the first metal layer towards the rest of the plurality of metal layers to form a metallurgical bond between the plurality of metal layers, and wherein a rate of a pressure rise is such that over about 50% of the pressure rise occurs in less than about 500 microseconds.

EXAMPLE 2: The method of any examples herein, particularly example 1, wherein the stack is substantially free of an intentional initial gap between one or more metal layers in the stack.

EXAMPLE 3: The method of any examples herein, particularly example 1 or 2, wherein a maximum value of the pressure is at least 2 times greater than a flow strength of at least one metal layer in the plurality of metal layers.

EXAMPLE 4: The method of any examples herein, particularly examples 1-3, wherein a maximum value of the pressure is at least 4 times greater than a flow strength of at least one metal layer in the plurality of metal layers.

EXAMPLE 5: The method of any examples herein, particularly examples 1-4, wherein the stack has a thickness from about 0.5 microns to about 4 mm.

EXAMPLE 6: The method of any examples herein, particularly examples 1-5, wherein a thickness of a metal layer in the plurality of metal layers is from about 0.5 microns to about 4 mm.

EXAMPLE 7: The method of any examples herein, particularly example 6, wherein each of the plurality of metal layers has the same thickness or a different thickness.

EXAMPLE 8: The method of any examples herein, particularly example 7, wherein at least one of the first metal layer or the last metal layer has a thickness greater than a thickness of the rest of the metal layers.

EXAMPLE 9: The method of any examples herein, particularly examples 1-8, wherein the stack comprises between about 2 to about 1000 metal layers.

EXAMPLE 10: The method of any examples herein, particularly examples 1-9, wherein the plurality of metal layers comprise aluminum, copper, zinc, titanium, iron, nickel, lithium alloys thereof, or alloys, or a combination thereof.

EXAMPLE 11: The method of any examples herein, particularly examples 1-10, wherein each of the plurality of metal layers is substantially similar to each other.

EXAMPLE 12: The method of any examples herein, particularly example 11, wherein the each of the plurality of metal layers comprises a substantially similar composition.

EXAMPLE 13: The method of any examples herein, particularly examples 11 or 12, wherein the each of the plurality of metal layers has a substantially similar geometry.

EXAMPLE 14: The method of any examples herein, particularly examples 11-13, wherein the each of the plurality of metal layers has a substantially similar thickness.

EXAMPLE 15: The method of any examples herein, particularly examples 1-10, wherein at least two metal layers in the plurality of metal layers are different.

EXAMPLE 16: The method of any examples herein, particularly example 15, wherein the at least two metal layers in the plurality of metal layers have a substantially different composition.

EXAMPLE 17: The method of any examples herein, particularly examples 15 or 16, wherein the at least two metal layers in the plurality of metal layers have a substantially different geometry.

EXAMPLE 18: The method of any examples herein, particularly examples 15-17, wherein the at least two metal layers in the plurality of metal layers have a substantially different thickness.

EXAMPLE 19: The method of any examples herein, particularly examples 15-18, wherein the at least two metal layers in the plurality of metal layers are adjacent to each other in the stack.

EXAMPLE 20: The method of any examples herein, particularly examples 15-19, wherein three or more of metal layers in the plurality of metal layers are different and positioned in alternating order in the stack.

EXAMPLE 21: The method of any examples herein, particularly examples 10-20, wherein at least some of alloys have a yield strength of less than about 800 MPa.

EXAMPLE 22: The method of any examples herein, particularly examples 1-21, wherein the pressure is generated by an energy source.

EXAMPLE 23: The method of any examples herein, particularly examples 1-22, wherein the step of imparting the pressure comprises accelerating an auxiliary member towards the first metal layer of the plurality of metal layers.

EXAMPLE 24: The method of any examples herein, particularly example 23, wherein the accelerating step comprises imparting an amount of energy to the auxiliary member.

EXAMPLE 25: The method of any examples herein, particularly examples 23 or 24, wherein the auxiliary member is consumable.

EXAMPLE 26: The method of any examples herein, particularly examples 23-25, wherein the auxiliary member is a multi-layer member.

EXAMPLE 27: The method of any examples herein, particularly examples 22-26, wherein the energy source generates the pressure through plasma, gas expansion by an electrical current, laser, electromagnetic source, detonation of an explosive and/or energetic material, electromagnetic repulsion, projectile of gun powder, spring projectile, or a combination thereof.

EXAMPLE 28: The method of any examples herein, particularly examples 22-27, wherein the energy source provides energy from about 1J to about 10 kJ.

EXAMPLE 29: The method of any examples herein, particularly example 28, wherein the energy source provides energy from about 0.1 kJ to about 10 kJ.

EXAMPLE 30: The method of any examples herein, particularly examples 23-29, wherein the auxiliary member is accelerated at a speed from about 200 m/s to about 1000 m/s.

EXAMPLE 31: The method of any examples herein, particularly examples 23-30, wherein at least a portion of the auxiliary member comprises an ablative material configured to vaporize during the accelerating step.

EXAMPLE 32: The method of any examples herein, particularly examples 23-31, wherein at least a portion of the auxiliary member comprises at least one chemical compound configured to react exothermically.

EXAMPLE 33: The method of any examples herein, particularly example 32, wherein the at least one compound is an explosive material configured to at least partially vaporize during the accelerating step.

EXAMPLE 34: The method of any examples herein, particularly examples 32-33, wherein the compound comprises sodium azide, nitromethane, pentaerythritol tetranitrate comprising material, one or more oxidants or oxidizing materials, gunpowder, nitroglycerine, or any combination thereof. In certain examples, the compound can comprise gunpowder and nitromethane. In certain examples, the compound can comprise nitroglycerine and nitromethane.

EXAMPLE 35: The method of any examples herein, particularly examples 31-34, wherein the ablative material is configured to evaporate and to impart kinetic energy as measured from 0.5 J/cm² to 5 KJ/cm² to the first metal layer of the plurality of metal layers.

EXAMPLE 36: The method of any examples herein, particularly examples 33-35, wherein the auxiliary member comprises aluminum, steel, copper, magnesium, zinc, nickel, lithium, or alloys or any combination thereof.

EXAMPLE 37: The method of any examples herein, particularly examples 32-36, wherein the auxiliary member comprises a transparent material configured to transmit energy from the energy source to the ablating material.

EXAMPLE 38: The method of any examples herein, particularly example 37, wherein the transparent material comprises water, a glass, or a transparent polymer.

EXAMPLE 39: The method of any examples herein, particularly examples 37-38, wherein the auxiliary member comprises a high shock impedance material.

EXAMPLE 40: The method of any examples herein, particularly example 39, wherein the auxiliary member comprises glycerin, water, or a combination thereof.

EXAMPLE 41: The method of any examples herein, particularly example 40, wherein the auxiliary multi-layer member is formed in-situ by providing a first stream of glycerin, water, or a combination thereof and a second layer or stream of sodium azide, nitromethane-comprising material, one or more oxidants or oxidizing materials, or any combination thereof.

EXAMPLE 42: The method of any examples herein, particularly examples 23-41, wherein the auxiliary member comprises one or more layers comprising a metal, a polymer, an adhesive material, a cushioning material, an elastomeric material, a sealing material, or any combination.

EXAMPLE 43: The method of any examples herein, particularly examples 23-42, wherein the auxiliary member is positioned on a supplementary member configured to project towards the first metal layer of the plurality of metal layers.

EXAMPLE 44: The method of any examples herein, particularly example 43, wherein the supplementary member comprises a metal or a non-metal material.

EXAMPLE 45: The method of any examples herein, particularly examples 43 or 44, wherein the supplementary member has a thickness of about 1 micrometer to about 5 mm.

EXAMPLE 46: The method of any examples herein, particularly examples 43-45, wherein the supplementary member is the metal material and wherein the metal material comprises a metal that is the same or different from any metal layers present in the plurality of metal layers.

EXAMPLE 47: The method of any examples herein, particularly examples 43-46, wherein the supplementary member is the metal material comprising aluminum, steel, copper, zinc, brass, any alloys thereof, or any combination thereof.

EXAMPLE 48: The method of any examples herein, particularly examples 1-47, wherein the last layer of the plurality of layers is positioned on a support material.

EXAMPLE 49: The method of any examples herein, particularly example 48, wherein a surface of the support material that is in contact with the last layer of the plurality of layers is flat, patterned, or a combination thereof.

EXAMPLE 50: The method of any examples herein, particularly examples 23-49, wherein the auxiliary member is positioned at a predetermined distance from the first metal layer of the plurality of metal layers.

EXAMPLE 51: The method of any examples herein, particularly example 50, wherein the predetermined distance is defined by one or more spacers positioned between the stack and the auxiliary member.

EXAMPLE 52: The method of any examples herein, particularly examples 1-51, wherein at least one of the plurality of metal layers is corrosion resistant.

EXAMPLE 53: The method of any examples herein, particularly examples 1-52, wherein at least one of the plurality of metal layers is scratch resistant.

EXAMPLE 54: The method of any examples herein, particularly examples 1-53, wherein at least one of the plurality of metal layers is a sacrificial layer.

EXAMPLE 55: The method of any examples herein, particularly examples 1-54, wherein more or two potions of the plurality of metal layers are welded.

EXAMPLE 56: The method of any examples herein, particularly examples 1-55, wherein the method is cladding.

EXAMPLE 57: A spot welded product produced by the method of any examples herein, particularly examples 1-56.

EXAMPLE 58: The spot welded product of any examples herein, particularly example 57, comprising multiple layers of a thin material joined to themselves or a base structure.

EXAMPLE 59: A welded product comprising: a stack comprising a plurality of metal layers; wherein the plurality of metal layers are welded to each other by the method of any examples herein, particularly examples 1-56, and wherein the welded product exhibits a lower electrical resistivity when compared to an electrical resistivity of a substantially identical reference stack that was not yet welded.

EXAMPLE 60: The welded product of any examples herein, particularly example 59, wherein at least one of the metal layers is coated.

EXAMPLE 61: The welded product of any examples herein, particularly example 59 or 60, wherein at least one of the metal layers is cladded to a base member by the methods of any one of claims 1-56, and wherein the base member has a greater thickness than the at least one metal layer.

EXAMPLE 62: A continuous seam weld formed between a plurality of metal layers formed by the methods of any examples herein, particularly examples 1-56, where the pressure rise is sequential and overlapping.

EXAMPLE 63: A system comprising: a stack comprising a plurality of metal layers; an auxiliary member configured to impart pressure to a first metal layer of the plurality of metal layers and such to cause a spot welding of the plurality of metal layers; and an energy source configured to accelerate the auxiliary multi-layer member toward the first metal layer of the plurality of metal layers.

1. A method for producing an impulse weld in a stack comprising a plurality of metal layers, wherein the method comprises:
imparting rising pressure to at least a portion of a first metal layer in the stack wherein the pressure is effective to project the first metal layer towards the rest of the plurality of metal layers to form a metallurgical bond between the plurality of metal layers,
wherein a rate of a pressure rise is such that over about 50% of the pressure rise occurs in less than about 500 microseconds; and
wherein the stack has a thickness from about 0.5 microns to about 4 mm; or
wherein a thickness of a metal layer in the plurality of metal layers is from about 0.5 microns to about 4 mm.

2. The method of claim 1, wherein the stack is substantially free of an intentional initial gap between one or more metal layers in the stack.

3. The method of claim 1, wherein a maximum value of the pressure is at least 2 times greater than a flow strength of at least one metal layer in the plurality of metal layers.

4. (canceled)

5. (canceled)

6. (canceled)

7. (canceled)

8. (canceled)

9. (canceled)

10. The method of claim 1, wherein the plurality of metal layers comprise aluminum, copper, zinc, titanium, iron, nickel, lithium alloys thereof, or alloys, or a combination thereof.

11. The method of claim 1, wherein
each of the plurality of metal layers is substantially similar to each other, and/or
wherein the each of the plurality of metal layers comprises a substantially similar composition; and/or
wherein the each of the plurality of metal layers has a substantially similar geometry; and/or
wherein the each of the plurality of metal layers has a substantially similar thickness.

12. (canceled)

13. (canceled)

14. (canceled)

15. The method of claim 1,
wherein at least two metal layers in the plurality of metal layers are different; and/or
wherein the at least two metal layers in the plurality of metal layers have a substantially different composition; and/or
wherein the at least two metal layers in the plurality of metal layers have a substantially different geometry; and/or
wherein the at least two metal layers in the plurality of metal layers have a substantially different thickness.

16. (canceled)

17. (canceled)

18. (canceled)

19. The method of claim 15, wherein the at least two different metal layers in the plurality of metal layers are adjacent to each other in the stack or wherein three or more of metal layers in the plurality of metal layers are different and positioned in alternating order in the stack.

20. (canceled)

21. (canceled)

22. The method of claim 1, wherein the pressure is generated by an energy source, and wherein the pressure is generated through plasma, gas expansion by an electrical current, laser, electromagnetic source, detonation of an explosive and/or energetic material, electromagnetic repulsion, projectile of gun powder, spring projectile, or a combination thereof.

23. The method of claim 1, wherein the step of imparting the pressure comprises accelerating an auxiliary member towards the first metal layer of the plurality of metal layers and/or wherein the accelerating step comprises imparting an amount of energy to the auxiliary member, wherein the auxiliary member is consumable, and wherein the auxiliary member is accelerated at a speed from about 200 m/s to about 1000 m/s.

24. (canceled)

25. (canceled)

26. (canceled)

27. (canceled)

28. (canceled)

29. The method of claim 22, wherein the energy source provides energy from about 0.1 kJ to about 10 kJ.

30. (canceled)

31. The method of claim 23, wherein at least a portion of the auxiliary member comprises an ablative material configured to vaporize during the accelerating step, and/or wherein at least a portion of the auxiliary member comprises at least one chemical compound configured to react exothermically.

32. (canceled)

33. (canceled)

34. The method of claim 31, wherein the compound comprises sodium azide, nitromethane, pentaerythritol tetranitrate comprising material, one or more oxidants or oxidizing materials, gunpowder, nitroglycerine, or any combination thereof.

35. The method of claim 31, wherein the ablative material is configured to evaporate and to impart kinetic energy as measured from 0.5 J/cm² to 5 kJ/cm² to the first metal layer of the plurality of metal layers.

36. (canceled)

37. The method of claim 31, wherein the auxiliary member comprises:
a transparent material configured to transmit energy from the energy source to the ablating material, wherein the transparent material comprises water, a glass, or a transparent polymer; and/or
wherein the auxiliary member comprises a high shock impedance material, wherein high shock impedance material comprises glycerin, water, or a combination thereof.

38. (canceled)

39. (canceled)

40. (canceled)

41. The method of claim 37, wherein the auxiliary multi-layer member is formed in-situ by providing a first stream of glycerin, water, or a combination thereof and a second layer or stream of sodium azide, nitromethane-comprising material, one or more oxidants or oxidizing materials, or any combination thereof.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. A welded product comprising:
a stack comprising a plurality of metal layers; wherein the plurality of metal layers are welded to each other by the method of claim 1,
and wherein the welded product exhibits a lower electrical resistivity when compared to an electrical resistivity of a substantially identical reference stack that was not yet welded.

60. The welded product of claim 59, wherein at least one of the metal layers is coated.

61. (canceled)

62. A continuous seam weld formed between a plurality of metal layers formed by the methods of claim 1, where the pressure rise is sequential and overlapping.

63. A system comprising:
a stack comprising a plurality of metal layers;
an auxiliary member configured to impart pressure to a first metal layer of the plurality of metal layers and such to cause a spot welding of the plurality of metal layers; and
an energy source configured to accelerate the auxiliary multi-layer member toward the first metal layer of the plurality of metal layers.
